(19) United States
(12) Patent Application Publication
(10) Pub. No.: US 2022/0203577 A1
(43) Pub. Date: Jun. 30, 2022

(54) Fixed Crank Driving Mechanism

(71) Applicant: Hangzhou Fangyuan Plastics Machinery Co., Ltd, Hangzhou City (CN)

(72) Inventors: Jianhua YUAN, Hangzhou City (CN); Guoqing YUAN, Hangzhou City (CN); Hangjie FU, Hangzhou City (CN); Jianping DONG, Hangzhou City (CN); Jialin YAO, Hangzhou City (CN); Yichao XU, Hangzhou City (CN); Zhongfa YING, Hangzhou City (CN)

(21) Appl. No.: 17/559,785

(22) Filed: Dec. 22, 2021

(30) Foreign Application Priority Data
Dec. 29, 2020 (CN) 202011587052.5

(51) Int. Cl. B29C 33/22; F16H 21/22; F15B 15/14

(52) U.S. Cl. CPC B29C 33/22; F15B 15/1457; F16H 21/22

(57) ABSTRACT

A fixed crank driving mechanism is provided, and belongs to the field of a crank driving mechanism, including a servo motor provided at one side of a fixed template, where the servo motor is in transmission connection with a rotating shaft, each end of two ends of the rotating shaft is connected with a crank, a tip end of the crank is movably connected with an elbow-shaped transmission arm, the elbow-shaped transmission arm is movably connected with a piston rod of an oil cylinder through a connecting seat, the connecting seat and the oil cylinder are fixedly provided on a movable template, the movable template is movable along guide posts, and one end of each of the guide posts is vertically and fixedly connected with the fixed template. The fixed crank driving mechanism reduces the weight of the movable template and the load of the servo motor.

### CROSS REFERENCE TO RELATED APPLICATION

This patent application claims the benefit and priority of Chinese Patent Application No. 202011587052.5 filed on Dec. 29, 2020, the disclosure of which is incorporated by reference herein in its entirety as part of the present application.

### TECHNICAL FIELD

The present disclosure relates to the field of crank driving mechanism technologies, in particular to a fixed crank driving mechanism.

### BACKGROUND ART

At present, the existing crank driving mechanism of an electric drive automatic molding machine on the market is basically fixedly installed on the movable template. So, such an installing mode increases the weight of the movable template, increases the friction between the movable template and the guide posts, and increases the load on the motor, thereby affecting the use of the machine. Conventional cranks are all fixedly connected. Accordingly, without position adjustment, it is likely that the positions of the left and right cranks are not absolutely consistent, which will frequently produce an extra lateral torque, increase the load of each part and affect the use of the machine.

### SUMMARY

The purpose of some embodiments is to provide a fixed crank driving mechanism to solve the above problems in the prior art, so as to reduce the weight of the movable template and the load of the servo motor. One end of each of the elbow-shaped transmission arms is connected with the oil cylinder, which has the function of compensating the gaps. So, the mold-locking force can be controlled, and the related parts and the mold can be prevented from being damaged when the cranks and the elbow-shaped transmission arms are at the position of a mechanical dead point where an infinite force is existed. The application of servo technology in this the fixed crank driving mechanism may realize the rapid operation of the template, so that the precision of the retained gaps after the mold is closed is less than 0.2 mm.

To achieve the above purpose, some embodiments provide the solutions as follows.

The present disclosure provides a fixed crank driving mechanism, including a servo motor provided at one side of a fixed template, where the servo motor is in transmission connection with a rotating shaft, each end of two ends of the rotating shaft is connected with a crank, a tip end of the crank is movably connected with an elbow-shaped transmission arm, the elbow-shaped transmission arm is movably connected with a piston rod of an oil cylinder through a connecting seat, the connecting seat and the oil cylinder are fixedly provided on a movable template, the movable template is movable along guide posts, and one end of each of the guide posts is vertically and fixedly connected with the fixed template.

Preferably, a speed reducer is fixedly installed on the one side of the fixed template, the servo motor is fixedly provided on the speed reducer, the rotating shaft extends through the speed reducer, and the servo motor is in transmission connection with the rotating shaft through the speed reducer.

Preferably, the each end of the two ends of the rotating shaft is installed on a bearing with seats, and the bearing with seats is fixedly provided on the fixed template.

Preferably, the connecting seat is provided with a waist-shaped hole parallel to the guide posts, a connecting pin extends through the waist-shaped hole, and the elbow-shaped transmission arm and the piston rod of the oil cylinder are rotatably connected through the connecting pin.

Preferably, the tip end of the crank is movably connected with the elbow-shaped transmission arm through a connecting shaft.

Preferably, the elbow-shaped transmission arm includes a first arm plate and a second arm plate which are symmetrically provided, the first arm plate and the second arm plate are fixedly connected to each other through connecting posts; the tip end of the crank is arranged between the first arm plate and the second arm plate, and the connecting shaft movably extends through the first arm plate, the tip end of the crank, and the second arm plate in sequence.

Preferably, the connecting seat includes a base fixedly connected with the movable template, two connecting side plates are fixedly provided on one side of the base which is close to the fixed template, each of the two connecting side plates is provided with the waist-shaped hole, the waist-shaped hole of one of the two connecting side plates is symmetrical to the waist-shaped hole of another one of the two connecting side plates, one end of the elbow-shaped transmission arm which is away from the crank is arranged between the two connecting side plates; the base is provided with a through hole, and the piston rod of the oil cylinder extends through the through hole of the base and is movably connected with the elbow-shaped transmission arm.

Preferably, the first arm plate is of an integrated structure, and the second arm plate and the first arm plate have a same structure.

Compared with the prior art, some embodiments have the technical effects as follows.

According to the fixed crank driving mechanism provided by some embodiments, the servo motor and the speed reducer are provided on the fixed template, which reduces the weight of the movable template and the load of the servo motor. One end of each crank is connected with the rotating shaft, and the other end thereof is movably connected with the elbow-shaped transmission arm through the connecting shaft. The cranks are simple to be installed, and the gaps at the ends of the rotating shaft are adjusted to ensure the consistent position of the cranks. The head of each oil cylinder is installed through the connecting pin in the waist-shaped hole of the connecting seat, which is adjustable by gaps. The mold-locking force can be controlled, the mechanical parts and the mold can be prevented from being damaged due to an infinite force at the mechanical dead point, and the service life of the machine is prevented from being shortened. The application of servo technology in this the fixed crank driving mechanism can realize the rapid operation of the template, so that the precision of the retained gaps after the mold is closed is less than 0.2 mm, and the operation efficiency and the use value of the fixed crank driving mechanism are improved.

### BRIEF DESCRIPTION OF THE DRAWINGS

In order to more clearly illustrate technical solutions in the embodiments of the present application or in the prior art, a brief introduction to the accompanying drawings required for the embodiment will be provided below. Obviously, the accompanying drawings in the following description are only some of the embodiments of the present disclosure. Those of ordinary skill in the art would also be able to derive other drawings from these drawings without making creative efforts.

FIG. 1 is a schematic structural diagram of a fixed crank driving mechanism according to the present disclosure.

FIG. 2 is a schematic top view of a fixed crank driving mechanism according to the present disclosure.

In the figures, 1 servo motor; 2 bearing with seats; 3 rotating shaft; 4 speed reducer; 5 connecting shaft; 6 crank; 7 elbow-shaped transmission arm; 8 connecting seat; 9 connecting pin; 10 oil cylinder; 11 movable template; 12 fixed template; 13 waist-shaped hole; 14 guide post, 15 connecting post, 16 first arm plate, 17 second arm plate, 18 base, 19 connecting side plate, 20 piston rod.

### DETAILED DESCRIPTION OF THE EMBODIMENTS

The technical solutions in the embodiments of the present disclosure will be clearly and completely described below in conjunction with the accompanying drawings in the embodiments of the present disclosure. Apparently, the described embodiments are only a part of the embodiments of the present disclosure, rather than all the embodiments. Based on the embodiments of the present invention, all other embodiments obtained by those of ordinary skill in the art without creative work shall fall within the protection scope of the present invention.

The purpose of the some embodiments is to provide a fixed crank driving mechanism to solve the above problems in the prior art, so as to reduce the weight of the movable template and the load of the servo motor. One end of each of the elbow-shaped transmission arms is connected with the oil cylinder, which has the function of compensating the gaps. The related parts can be prevented from being damaged when the crank and the elbow-shaped transmission arm are at the position of a mechanical dead point where an infinite force is existed.

In order to make the objectives, features, and advantages mentioned above of the present disclosure more apparent and easily understood, the present disclosure will be further described in detail below with reference to the drawings and particular implementations.

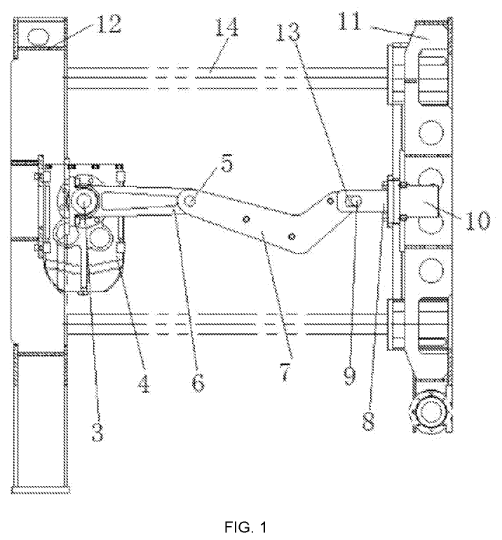

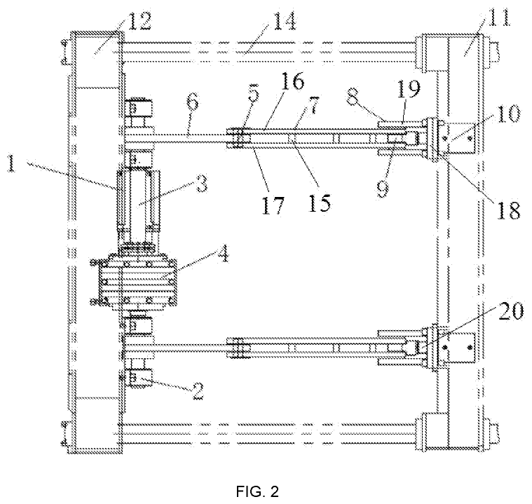

The present disclosure provides a fixed crank driving mechanism, as shown in FIGS. 1 and 2, including a servo motor 1, bearings with seats 2, a rotating shaft 3, a speed reducer 4, connecting shafts 5, cranks 6, elbow-shaped transmission arms 7, connecting seats 8, connecting pins 9 and oil cylinders 10. The elbow-shaped transmission arm 7 includes a first arm plate 16 and a second arm plate 17 which are symmetrically arranged. The first arm plate 16 and the second arm plate 17 are fixedly connected to each other by connecting posts 15 or pins. One end of the crank 6 is arranged between the first arm plate 16 and the second arm plate 17. The connecting shaft 5 movably extends through the first arm plate 16, the end of the crank 6 and the second arm 17 plate in sequence. The connecting seat 8 includes a base 18 fixedly connected with the movable template 11. Two connecting side plates 19 are fixedly provided on one side of the base 18 which is close to the fixed template 12. Each of the two connecting side plates 19 is provided with one corresponding waist-shaped hole 13, and the two waist-shaped holes 13 are symmetrically provided. The one end of the elbow-shaped transmission arm 7 which is away from the crank 6 is arranged between the two connecting side plates 19. The base 18 is provided with a through hole. The piston rod 20 of the oil cylinder 10 extends through the through hole of the base 18 and is movably connected with the elbow-shaped transmission arm 7. The speed reducer 4 is fixedly installed on the fixed template 12, and the servo motor 1 is installed on the speed reducer 4. The rotating shaft 3 is extended through and connected to the speed reducer 4 at a middle portion of the speed reducer 4. Both ends of the rotating shaft 3 are fixed by the respective bearings with seats 2. The bearings with seats 2 are fixedly installed on the fixed template 12, and each of the both ends of the rotating shaft 3 is installed with the crank 6. The elbow-shaped transmission arm 7 is connected with the end of the crank 6 through the connecting shaft 5. The connecting seats 8 are fixed on the movable template 11. The oil cylinder 10 and the connecting seat 8 are both fixed on the movable template 11. The elbow-shaped transmission arm 7 is connected with the piston rod 20 of the oil cylinder 10 through the connecting pin 9 on the connecting seat 8. The waist-shaped hole 13, which is in the horizontal direction, of the connecting seat 8 is configured for installing the connecting pin 9. When the servo motor 1 rotates, the cranks 6 are driven to rotate, and the cranks 6 push the respective elbow-shaped transmission arms 7. There is an adjustable gap in the horizontal direction at the joint of each elbow-shaped transmission arm 7 and the head of the piston rod 20 of a corresponding oil cylinder 10, and the gap has the same length as the waist-shaped hole 13. The elbow-shaped transmission arms 7 push the respective oil cylinders 10 and the movable template 11 to move horizontally along the guide posts 14. When the movable template is in the closed place, the oil cylinders 10 and the movable template 11 are fixed. Furthermore, the piston rod 20 of each oil cylinder 10 drives the corresponding connecting pin 9 to move in the respective waist-shaped hole 13, and thus the piston rod 20 of each oil cylinder 10 pushes the corresponding elbow-shaped transmission arm 7 to lock the mold.

Specific embodiments are used in this specification for illustration of the principles and implementations of the present disclosure. The description of the above embodiments is merely used to help understand the method and core concept of the present disclosure. In addition, those of ordinary skill in the art may make modifications to the specific implementations and application scope in accordance with the concept of the present disclosure. In conclusion, the content of this specification should not be construed as a limitation to the present disclosure.

What is claimed is:

1. A fixed crank driving mechanism, comprising:
a servo motor provided at one side of a fixed template, wherein the servo motor is in transmission connection with a rotating shaft, each end of two ends of the rotating shaft is connected with a crank, a tip end of the crank is movably connected with an elbow-shaped transmission arm, the elbow-shaped transmission arm is movably connected with a piston rod of an oil cylinder through a connecting seat, the connecting seat and the oil cylinder are fixedly provided on a movable template, the movable template is movable along guide posts, and one end of each of the guide posts is vertically and fixedly connected with the fixed template.

2. The fixed crank driving mechanism according to claim 1, wherein a speed reducer is fixedly installed on the one side of the fixed template, the servo motor is fixedly provided on the speed reducer, the rotating shaft extends through the speed reducer, and the servo motor is in transmission connection with the rotating shaft through the speed reducer.

3. The fixed crank driving mechanism according to claim 2, wherein the each end of the two ends of the rotating shaft is installed on a bearing with seats, and the bearing with seats is fixedly provided on the fixed template.

4. The fixed crank driving mechanism according to claim 1, wherein the connecting seat is provided with a waist-shaped hole parallel to the guide posts, a connecting pin extends through the waist-shaped hole, and the elbow-shaped transmission arm and the piston rod of the oil cylinder are rotatably connected through the connecting pin.

5. The fixed crank driving mechanism according to claim 1, wherein the tip end of the crank is movably connected with the elbow-shaped transmission arm through a connecting shaft.

6. The fixed crank driving mechanism according to claim 5, wherein the elbow-shaped transmission arm comprises a first arm plate and a second arm plate which are symmetrically provided, the first arm plate and the second arm plate are fixedly connected to each other through connecting posts; the tip end of the crank is arranged between the first arm plate and the second arm plate, and the connecting shaft movably extends through the first arm plate, the tip end of the crank, and the second arm plate in sequence.

7. The fixed crank driving mechanism according to claim 4, wherein the connecting seat comprises a base fixedly connected with the movable template, two connecting side plates are fixedly provided on one side of the base which is close to the fixed template, each of the two connecting side plates is provided with the waist-shaped hole, the waist-shaped hole of one of the two connecting side plates is symmetrical to the waist-shaped hole of another one of the two connecting side plates, one end of the elbow-shaped transmission arm which is away from the crank is arranged between the two connecting side plates; the base is provided with a through hole, and the piston rod of the oil cylinder extends through the through hole of the base and is movably connected with the elbow-shaped transmission arm.

8. The fixed crank driving mechanism according to claim 6, wherein the first arm plate is of an integrated structure, and the second arm plate and the first arm plate have a same structure.
